(19) United States
(12) Patent Application Publication
(10) Pub. No.: US 2006/0169770 A1
(43) Pub. Date: Aug. 3, 2006

(54) Sheet handling apparatus

(76) Inventors: Hisahiro Koshizuka, Hitachinaka (JP); Kazushi Yoshida, Kasumigaura (JP); Hiroshi Ikeda, Kasumigaura (JP); Riichi Katou, Nagoya (JP); Shinji Shibata, Nagoya (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/341,657

(22) Filed: Jan. 30, 2006

(30) Foreign Application Priority Data
Jan. 31, 2005 (JP) 2005-023064

(51) Int. Cl. G06F 7/08; G07F 19/00

(52) U.S. Cl. 235/381; 235/379

(57) ABSTRACT

A banknote handling apparatus comprises: a deposit-and-withdrawal port unit to or from which banknotes to be transacted are injected or discharged; and a banknote handling unit connected to the deposit-and-withdrawal port unit through a conveying route to discriminate the validity of a banknote and take in and discharge the banknote, wherein the conveying route of the deposit-and-withdrawal port unit is spaced from the conveying route of the banknote handing unit, and the conveying route of the deposit-and-withdrawal port unit and that of the banknote handling unit are connected through a connection conveying route unit, and wherein the banknote handling unit is placed inside of a wall, and only the deposit-and-withdrawal port unit is placed in the through-hole of the wall, thereby the opening area of the through-hole of the wall is decreased.

### TECHNICAL FIELD

The present invention relates to a sheet handling apparatus, particularly to a sheet handling apparatus in which the major portion of the apparatus including a cashbox of banknotes and a deposit-and-withdrawal port to which a user makes an access are positioned at both sides of a wall.

### BACKGROUND OF THE INVENTION

A sheet handling apparatus includes a through-the-wall-type of apparatus in which a deposit-and-withdrawal port to which a user makes an access is positioned in a through-hole opening outward on a wall and the major portion of the sheet handling apparatus including a cashbox is positioned inside of the wall, as well as an indoor type of apparatus placed in a managed room, in which a deposit-and-withdrawal port to which a user makes an access and the major portion of the apparatus including a cashbox are formed integrally.

For example, according to the through-the-wall-type of sheet handling apparatus disclosed in JP-A-2004-110289, a cashbox is positioned inside of a wall and the major portion of the sheet handling apparatus and a deposit-and-withdrawal port are formed protruding into a through-hole portion in the wall, so that the deposit-and-withdrawal port is approaching to a user to improve an operability even if there is a thick wall.

### SUMMARY OF THE INVENTION

When a through-the-wall-type of sheet handling apparatus is installed, it is preferable to place a cashbox inside of a hard thick wall from a viewpoint of crime prevention. Therefore, it is preferable that a through-hole has a smaller opening area from the viewpoint of crime prevention, and it is possible to restrain the cost of construction.

However, according to the prior art disclosed in JP-A-2004-110289, sufficient consideration is not made for reduction of the opening area of a through-hole. That is, according to the Document, an apparatus height of the deposit-withdrawal port portion located in the through-hole of a wall is increased and an opening area is obliged to be increased, because the deposit-withdrawal port portion having a transaction port through which a banknote to be transacted is injected or discharged is integrated with a bill handing portion for discriminating the validity of banknotes to be transacted and taking in and discharging the banknotes.

An object of the present invention is to decrease an opening area of a through-hole in a sheet handling apparatus, in which a sheet handling portion is disposed on the other side of a transaction port portion through a wall.

To solve the above problem, the present invention uses a sheet handling apparatus comprising: a transaction port unit into or from which a sheet is injected or discharged; and a sheet handling unit connected to the transaction port unit through a sheet conveying route, which discriminates the validity of sheets to take in and discharge the sheet, wherein a sheet conveying route of the transaction port unit is spaced from a sheet conveying route of the sheet handling unit, and the sheet conveying routes of the transaction port unit, and the sheet handling unit are connected through a connection conveying route unit.

Because the transaction port unit is spaced from the sheet handing unit, and they are connected through the connection conveying route unit, it is possible to place the sheet handling unit inside of a wall. Moreover, because only the transaction port unit can be placed in the through-hole of a wall, it is possible to decrease the opening area of the through-hole of the wall compared to the case of integrating the transaction port units with the sheet handling unit.

In this case, it is preferable that the sheet handling unit is placed inside of the wall of a building and the transaction port unit is positioned in a through-hole passing through the wall. Moreover, it is preferable that a connection end of the sheet conveying route of the connection conveying route unit with the sheet handling unit is positioned inside of the wall.

Moreover, it is possible to form the connection conveying route unit to include a substantially horizontal sheet conveying route, and form the connection conveying route unit so as to have a imaginary plane which is vertical to a conveying direction and in which the deposit-withdrawal port unit or the sheet handling unit is not present.

Furthermore, it is preferable to constitute the transaction port unit to be connected to one end of the sheet conveying route of the conveying route unit. Thereby, only the height of the deposit-withdrawal port unit is taken into consideration for the opening area of the through-hole of the wall.

Instead of the above, it is possible to place the deposit-withdrawal port unit to overlay at least a part of the connection conveying route unit. Thereby, although the opening area of the through-hole of the wall is increased by the height of the connection conveying route unit, that height can be generally decreased, and the configuration can be applied to a case where the wall is thin. In this case, the sheet conveying route of the transaction port unit is necessary to be formed to include a vertical conveying route connected to the connection conveying route unit.

The sheet conveying route of the connection conveying route unit can be formed as a one-mouth conveying route which is capable of conveying sheets in two ways by changing conveying directions. Alternatively, it is possible to form the sheet conveying route as a two-mouth conveying route having a first conveying route for conveying sheets to the sheet handling unit and a second conveying route for conveying sheets to the deposit-withdrawal port unit.

When the transaction port unit is constituted to have separation means for separating sheets injected into the transaction port one by one to take them in and discharge means for discharging sheets to the transaction port, the sheet conveying route of the separation means and that of the discharge means can be interflowed and connected to the bidirectional sheet conveying route of the connection conveying route unit.

The present invention makes it possible to decrease the opening area of the through-hole in the sheet handling apparatus in which a sheet handling portion is on the other side of the transaction port through the wall.

Other objects, features and advantages of the invention will become apparent from the following description of the embodiments of the invention taken in conjunction with the accompanying drawings.

### BRIEF DESCRIPTION OF THE DRAWINGS

FIG. 1 is a sectional view of a banknote handling apparatus of an embodiment of the present invention viewed from a side of the installed apparatus;

FIG. 2 is a perspective view of the banknote handling apparatus of the embodiment in FIG. 1;

FIG. 3 is a control block diagram of the banknote handling apparatus of the embodiment in FIG. 1;

FIG. 4 is a detailed sectional view of the banknote handling apparatus of the embodiment in FIG. 1;

FIG. 5 is a sectional view of the essential portion of a banknote handling apparatus of further embodiment of the present invention;

FIG. 6 is a sectional view of the essential portion of a banknote handling apparatus of still further embodiment of the present invention; and

FIG. 7 is a sectional view of the essential portion of a banknote handling apparatus of still further embodiment of the present invention.

### DETAILED DESCRIPTION OF THE INVENTION

### Embodiment 1

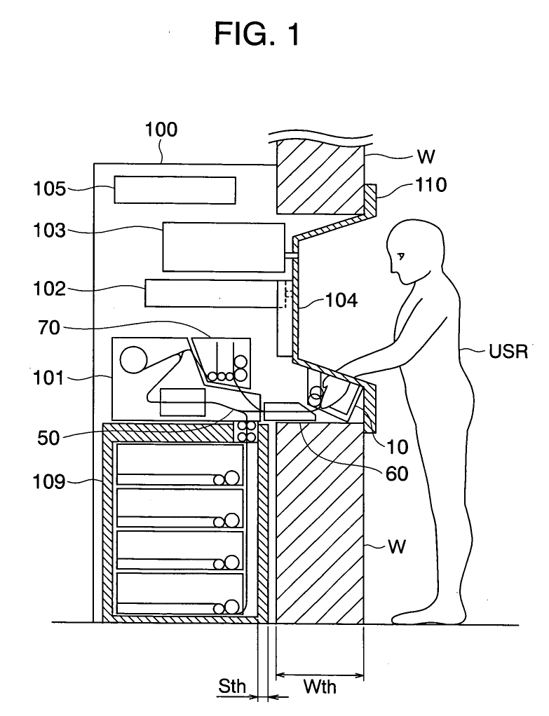

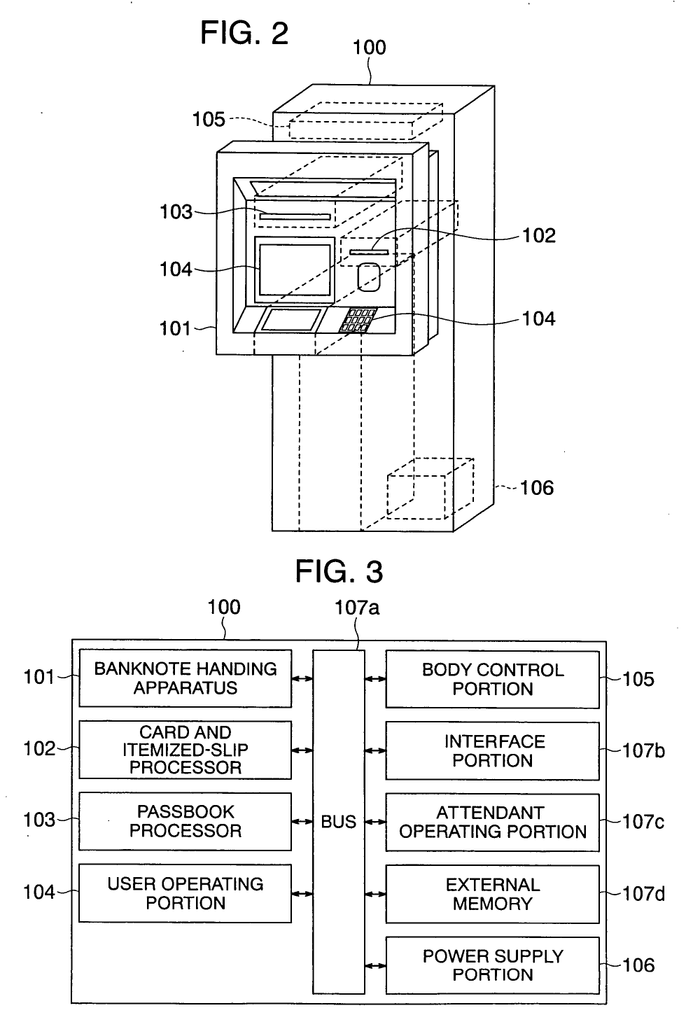

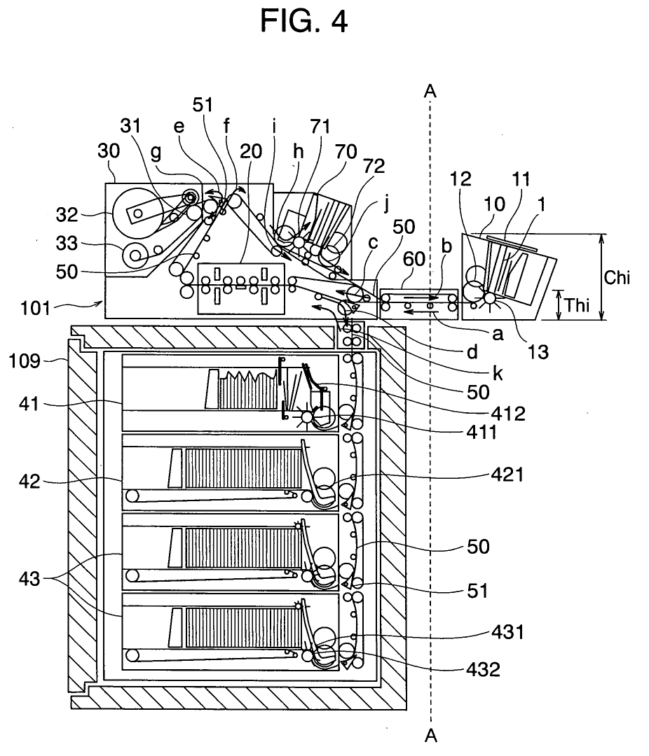

An embodiment of a sheet handling apparatus of the present invention is described below with referring to FIGS. 1 to 4. FIG. 1 is a sectional view viewed from a side of an embodiment in which a sheet handling apparatus of the present invention is applied to an automatic teller machine installed in a financial institute and the like. FIG. 2 is a perspective view of the automatic teller machine in FIG. 1. FIG. 3 is a functional block diagram of a controller. FIG. 4 is a sectional view showing the detail of a major portion of the automatic teller machine in FIG. 1.

As shown in FIG. 1, the automatic teller machine 100 of this embodiment is a through-the-wall-type of automatic teller machine installed with passing through a wall W. A through-hole, which is rectangular for example, formed on the wall W is fenced off by a front panel 110 formed to be concaved from the external wall face. The automatic teller machine 100 is constituted to comprise a deposit-withdrawal port unit 10 through which a user “USR” injects a banknote (deposited money) or a banknote is discharged (withdrawn money) to the user “USR”, a banknote handling unit 101 for discriminating validity of a banknote to be transacted and taking in and discharging a banknote, a cashbox 109, and the like, and is installed inside of the wall W.

As shown in FIG. 2, a card-and-itemized-slip processor 102 for processing the card of a user and printing and discharging an itemized slip, and a passbook processor 103 for recording transaction contents in the passbook of the user are provided in the backside of the front panel 110. Moreover, as shown in FIG. 2, a user operating portion 104 for displaying a guidance for the user and inputting a designation from the user is provided on the front panel 110. Furthermore, a body control portion 105 for monitoring and controlling the present apparatus and a power supply portion 106 for supplying power to each component are placed inside the automatic teller machine 100.

A slope whose deeper side becomes higher is formed at the concave portion of the front panel 110, and an opening is formed at the slope. A deposit-and-withdrawal port unit 10 having a transaction port through which a banknote to be transacted is injected or discharged is formed facing the opening. Banknote conveying routes of the deposit-and-withdrawal port unit 10 and banknote handing unit 101 are connected through a connection conveying route unit 60.

The cashbox 109 is formed from a durable iron plate for surrounding a deposit cashbox 41, a withdrawal cashbox 42, and a backflow cashbox 43. The deposit cashbox 41 is a cashbox for storing banknotes when transaction at the time of money deposit is effected. The withdrawal cashbox 42 is a cashbox for storing banknotes for withdrawal. The backflow cashbox 43 is a cashbox serving for deposit and withdrawal. A conveying route 50 for conveying banknote between the deposit cashbox 41, withdrawal cashbox 42 and backflow cashbox 43, and banknote handling unit 101 is formed to pass through the cashbox 109. All banknotes are present only in the cashbox 109 except during transaction, so that security is improved. Moreover, the cashbox 109 is normally closed and can be opened only by a predetermined attendant. The cashbox 109 is opened according to necessity to perform maintenance by bringing out the deposit cashbox 41, withdrawal cashbox 42, and backflow cashbox 43.

As shown in FIG. 3, the body control portion 105 is connected to the banknote handling unit 101, the card-and-itemized-slip processor 102, the passbook processor 103, and the user operating portion 104 through a bus 107a. Moreover, the body control portion 105 is connected to an interface portion 107b which is connected to an external host computer, an attendant operating portion 107c which is operated by an attendant at the time of maintenance, and an external memory 107d through the bus 107a. Thereby, the body control portion 105 executes the control necessary for the automatic teller machine 100 and exchanges necessary data with an external unit.

Because the thickness “Wth” of the wall W shown in FIG. 1 depends on a building, when the wall thickness “Wth” is large, the distance between the banknote handling unit 101 positioned inside of the wall and the front panel 110 positioned in the front of the wall is increased. Moreover, the wall thickness “Sth” of the cashbox 109 varies. As the cashbox 109 is increased in wall thickness and weight, security is more improved. However, as the wall thickness of the cashbox is increased, the distance between the banknote handling unit 101 and the front panel 110 is increased. Moreover, when the through-hole of the wall W in which the front panel 110 is installed is formed in an existing wall, it is preferable to decrease the size of the through-hole in order to decrease the cost of construction and also from the viewpoint of security.

Configurations of the deposit-and-withdrawal port unit 10, the banknote handling unit 101, and the connection conveying route unit 60 are described in detail with referring to FIG. 4, which are characterizing portion of the present embodiment and possible to decrease the size of the through-hole of the wall W in which the front panel 110 is installed. The banknote handling unit 101 is constituted to include a banknote discriminating portion 20 for discriminating banknotes, a temporary cabinet 30 for temporarily storing deposited banknotes until transaction is effected, and a deposit money reject storage 70. The banknote discriminating portion 20, the temporary cabinet 30, and the deposit money reject storage 70 are connected by the conveying route 50 for conveying banknotes.

The deposit-and-withdrawal port unit 10 is provided with a deposit-and-withdrawal port opened to the outside of the front panel 110 through a shutter 11. At the timing when transaction is required such as the time of deposit or withdrawal, the shutter 11 opens and a user can inject banknotes 1 into the deposit-and-withdrawal port or takes out the banknotes 1 therefrom. The injected banknotes 1 are separated one by one by a separating mechanism 12 comprising a plurality of rollers and sent to the connection conveying route unit 60. Banknotes conveyed from the banknote handling unit 101 by the connection conveying route unit 60 are collected by a collecting mechanism 13 comprising a guide for leading the banknotes by deforming them into wave shapes and a sheet roller in which elastic members are radially arranged to inject the banknotes into a space of the deposit-and-withdrawal port and press lower ends of the collected banknotes to secure a storage space, and then the banknotes are discharged to a user.

In the case of the embodiment in FIG. 4, the same one-mouth conveying route is used in both a banknote bring-out port (separating port) where banknotes are separated by the separating mechanism 12 of the deposit-and-withdrawal port unit 10 and a banknote bring-in port (collecting port) of banknotes to which the banknotes of the collecting mechanism 13 are conveyed. However, a two-mouth conveying route can be also used in which a separating port and a collecting port are separately provided.

The banknote discriminating portion 20 measures optical and magnetic features of the banknotes conveyed from the connection conveying route unit 60 through the conveying route 50 to discriminate the kind and authenticity of money of conveyed banknotes. Moreover, the banknote discriminating portion 20 detects overlap of a plurality of banknotes (overlap sending), too short interval between them (short pitch), and large skew to determine whether a banknote cannot be conveyed.

The temporary cabinet 30 is constituted to include an induction tape 31 for winding banknotes, rotating drum 32 for winding banknotes conveyed with the induction tape 31, and winding shaft 33 for winding only the induction tape 31. The temporary cabinet 30 has independent driving motors for driving the rotating drum 32 and winding shaft 33 to wind banknotes on the rotating drum 32 together with the induction tape 31 and store them or discharges them from the rotating drum 32 together with the induction tape 31. That is, the temporary cabinet 30 is a portion for temporarily storing conveyed banknotes. For example, the temporary cabinet 30 temporarily stores a banknote deposited from a user. When the user recognizes transaction, the banknote is stored in the deposit cashbox 41 or backflow cashbox 43. When the user does not recognize transaction, however, the banknote is conveyed to the deposit-and-withdrawal port unit 10 and returned to the user.

The deposit money reject storage 70 stores a banknote whose type of money cannot be discriminated by the banknote discriminating portion 20 at the time of deposit or a banknote which cannot be conveyed due to overlap sending, short pitch, or large skew. The deposit money reject storage 70 is composed of a collecting mechanism 71 comprising a brush roller in which elastic members are radially arranged and a guide formed complicatedly together with the brush roller to stop a conveyed banknote by a frictional force, and a separating mechanism 72 comprising a plurality of rollers for separating banknotes by a frictional force. The deposit money reject storage 70 is placed inner than the connection conveying rout unit 60 inside of a wall.

The deposit cashbox 41 is composed of a collecting mechanism 411 comprising a brush roller in which elastic members are radially arranged and a guide formed complicatedly together with the brush roller to stop a conveyed banknote by a frictional force, and a storing mechanism 412 for storing banknotes collected by the collecting mechanism 411 in the inside of the deposit cashbox. The deposit cashbox 41 stores a banknote which is only deposited but not back flown or a banknote which cannot be conveyed due to overlap sending, short pitch, or large skew. The withdrawal cashbox 42 has a separating mechanism 421 comprising a plurality of rollers for separating banknotes by a frictional force to separate banknotes in the withdrawal cashbox 42 set by an attendant for sending the banknotes to the conveying route 50 one by one. The backflow cashbox 43 is composed of a separating mechanism 431 comprising a plurality of rollers for separating banknotes by a frictional force and a collecting mechanism 432 comprising a sheet roller for injecting a banknote conveyed to the backflow cashbox to a storage space. Banknotes conveyed through the conveying route 50 at the time of deposit transaction are collected by the collecting mechanism 432. At the time of withdrawal transaction, the banknotes in the backflow cashbox are discharged to the conveying route 50 by the separating mechanism 431. This embodiment includes one deposit cashbox 41, one withdrawal cashbox 42, and two backflow cashboxes 43. They can be freely combined and the number of cashboxes can be changed freely. For example, it is allowed to combine two deposit cashboxes 41 and three backflow cashboxes 43.

The conveying route 50 is composed of a belt and rollers for holding a banknote and a driving motor for driving the belt and rollers. A change gate 51 driven by an electromagnetic solenoid is placed at the branch point of the conveying route 50 and thereby it is possible to change banknote conveying directions. Therefore, by changing the rotating direction of the driving motor and the change gate at every transaction operation, a banknote bidirectionally passes through the banknote discriminating portion 20 and is conveyed through the deposit money reject storage 70, temporary cabinet 30, deposit cashbox 41, withdrawal cashbox 42, and backflow cashbox 43.

Each unit, such as the deposit-and-withdrawal port unit 10, connection conveying route unit 60, banknote handling unit 101, cashbox 109, and conveying route 50, is controlled in accordance with a transaction by a control portion (not illustrated) connected with the driving motor of each unit, actuator such as an electromagnetic solenoid, or sensor. It is controlled in accordance with an instruction supplied from the body control portion 105, or those states are reported to the body control portion 105.

The connection conveying route unit 60 which is a feature of this embodiment is composed of a belt and rollers for holding a banknote. In this case, in order to decrease the dimension in height, it is preferable that the plane in which banknotes are conveyed is substantially horizontal. It is possible to connect the belt and rollers to a driving mechanism for driving the conveying route 50 through a gear to drive them. However, it is also possible to independently constitute the connection conveying route unit 60 to include a driving motor independent of the conveying route 50. Moreover, as shown in FIG. 4, the connection conveying route unit 60 can be composed of one conveying route driven in directions of arrows “a” and “b” . Thereby, it is possible to realize a connection conveying route having a small dimension in height.

The both ends of the connection conveying route unit 60 are connected to the deposit-and-withdrawal port unit 10 and the conveying route of the banknote discriminating portion 20. Furthermore, the connection conveying route unit 60 is formed so that it can be removed independently of the deposit-and-withdrawal port unit 10 and banknote discriminating portion 20 and it can be replaced. Thereby, for example, by changing the conveying rout length of the connection conveying route unit 60, it can be applied to various thicknesses of walls and cashboxes, without changing the constitution of the deposit-and-withdrawal port unit 10 connected to the front panel 110 or banknote handling unit 101.

Because the connection conveying route unit 60 conveys only each banknote separated by the deposit-and-withdrawal port unit 10, clogging can be restrained. Furthermore, because a banknote or a foreign matter clogged at the time of separation in the deposit-and-withdrawal port unit 10 is collected in the deposit-and-withdrawal port unit 10, a user can remove the banknote or foreign matter. Therefore, it hardly results in a state in which operation is stopped until an attendant restores.

When considering any substantially vertical cross section passing through the connection conveying route unit 60 of this embodiment, the unit 60 is constituted so that the cross section A-A is provided in which no units of banknote handling apparatuses, such as the deposit-and-withdrawal port unit 10, banknote discriminating portion 20, deposit cashbox 41, withdrawal cashbox 42, and backflow cashbox 43 other than the connection conveying route unit 60 are present. By using this constitution, only connection conveying route unit 60 by which banknotes are conveyed is provided between the banknote handling unit 101 inside of a wall and the deposit-and-withdrawal port unit 10 connected to the front panel 110 at the front of the wall. Therefore, the connection portion to the front panel 110 can be downsized.

The banknote handling unit 101 may be drawn out backward from the wall surface for maintenance operation. In this case, the connection conveying route unit 60 and deposit-and-withdrawal port unit 10 may pass through the through-hole in the wall. Therefore, to decrease the through-hole in wall in size, it is required to minimize the dimension in height of the connection conveying route unit 60 and deposit-and-withdrawal port unit 10. However, the height of the deposit-and-withdrawal port unit 10 cannot be decreased to less than a predetermined value because of the size of a banknote to be handled or operability of a user. Therefore, the maximum height “Thi” of the connection conveying route unit 60 must be smaller than the maximum height “Chi” of the deposit-and-withdrawal port unit 10.

Operations of the automatic teller machine 100 at the time of transaction are described below with referring to FIG. 4. The automatic teller machine 100 performs transactions such as deposit, deacquisition, transfer, passbook record, balance collation, and money change by using a card, banknote, itemized slip, or passbook as a medium. First, a guidance for executable transactions is displayed on the user operating portion 104. The user designates a transaction to be performed through the user operating portion 104. First, a case is described in which deposit is selected. When deposit is selected by a user, a guidance is displayed on the user operating portion 104 so as to insert a card and passbook into the card-and-itemized-slip processor 102 or passbook processor 103. When accepting the card and passbook, the shutter 11 of the deposit-and-withdrawal port unit 10 is opened to wait for a banknote to be injected. The user injects banknotes 1 into the deposit-and-withdrawal port unit 10. Thereby, the automatic teller machine 100 starts the operation for deposit processing.

The banknotes 1 injected into the deposit-and-withdrawal port unit 10 are separated one by one and conveyed through the connection conveying route unit 60 in the direction of an arrow “a” and sent to the conveying route 50. The banknotes pass through the conveying route 50 in the direction of an arrow “c” and are conveyed to the banknote discriminating portion 20. The banknote discriminating portion 20 discriminates the type of money, authenticity, and conveying attitude of banknotes. Acceptable banknotes are conveyed in the direction of an arrow “e” and temporarily stored in the temporary cabinet 30. Banknotes whose type of money cannot be discriminated by the banknote discriminating portion 20 and banknotes which cannot be conveyed due to overlap sending, short pitch, or large skew are conveyed from an arrow “f” to the direction of an arrow “h” and temporarily stored in the deposit-money reject storage 70 (collecting mechanism 71). When banknotes are stored in the deposit money reject storage 70, the deposit-and-withdrawal port unit 10 separates all banknotes, and then the deposit-money reject storage separates stored banknotes (separating mechanism 72). Banknotes are conveyed to the direction of an arrow “b” from an arrow “j”, collected in the deposit-and-withdrawal port unit 10, and returned to the user. The user can inject banknotes into the deposit-and-withdrawal port unit 10 according to necessity.

When there is not a banknote stored in the deposit-money reject storage 70 or a banknote to be re-injected into the deposit-and-withdrawal port unit 10, an amount of counted money is displayed on the user operating portion 104 and confirmation is requested to the user. When the amount of counted money is approved by the user, the banknotes in the temporary cabinet 30 pass in the directions “g” and “d”, stored in either of the deposit cashbox 41 or backflow cashbox 43, and thus the deposit operation is completed. Thereafter, according to a result of the transaction, the card-and-itemized-slip processor 102 processes a card-and-itemized slip, and then the passbook processor 103 records data in a passbook and discharges the data to the user. Thus, deposit transaction is completed.

Next, a case in which withdrawal is selected is described. When withdrawal is selected by a user, a guidance is displayed on the user operating portion 104 so as to insert a card and passbook into the card-and-itemized-slip processor 102 or passbook processor 103. When accepting the card and passbook, a guidance is displayed so as to input an identification number to the user operating portion. When the user inputs the identification number and the identification number is approved, a guide is displayed so as to input the amount of withdrawal.

Thereafter, the banknote handling unit 101 delivers the amount of banknotes designated by the withdrawal cashbox 42 or backflow cashbox 43 to the conveying route 50. The delivered banknotes pass in the direction of an arrow “k” and are conveyed to the banknote discriminating portion 20. The banknote discriminating portion confirms the type of money and conveying attitude of banknotes. Banknotes discriminated so that withdrawal to a user is improper pass through an arrow “e” and are temporarily stored in the temporary cabinet 30. Banknotes discriminated so that withdrawal is allowed pass through arrows “f”, “i”” and “b”, and are collected in the deposit-and-withdrawal port unit 10. When designated amount of money is collected in the deposit-and-withdrawal port unit 10, the shutter 11 is opened and the mount of money is discharged to the user. When banknotes are stored in the temporary cabinet 30, the banknotes pass in directions of arrows “g” and “d”, and are stored in the deposit cashbox 41, and thus the withdrawal operation is completed. Thereafter, the card-and-itemized-slip processor 102 processes a card and itemized slip in accordance with a transaction result, and the passbook processor 103 record data in a passbook and discharge the data to the user. Thus, the deposit operation is completed.

As described above, according to this embodiment, by only changing the length of the connection conveying route unit 60, it can be applied to various wall thicknesses “Wth” and the thickness “Sth” of the cashbox 109. Moreover, because the connection portion with the front panel 110 is composed of only a separating mechanism for separating banknotes injected by a user and the deposit-and-withdrawal port unit 10 provided with a collecting mechanism for collecting banknotes to be discharged to the user, it is possible to place only the deposit-and-withdrawal port unit 10 in the through-hole of a wall, and downsize the connection portion with the front panel 110 to decrease the through-hole in the wall in size. In this case, when the connection end between the connection conveying route unit 60 and the banknote handling unit 101 is positioned inside of the wall, it is not necessary to spread the hole of the wall for the banknote handling unit 101, and the through-hole can be decreased in size. Moreover, because banknotes are separated in the deposit-and-withdrawal port unit 10, it is possible to easily remove a clogged banknote when separated or foreign matter.

In the case of a general banknote handling apparatus, it is considered to send a plurality of banknotes injected into a deposit-and-withdrawal port through a general conveying route in a lump to a banknote handling unit which separate the banknotes. In this case, because the general conveying route can be composed of a comparatively simple structure such as a belt and rollers capable of holding a banknote bundle, it is effective in downsizing. When a transaction is interrupted due to foreign matter mixed in banknotes erroneously injected by a user or banknotes clogged at the time of separation in a banknote handling unit, it is necessary to return the banknotes and foreign matter to the user. However, because a banknote clogged in a separating portion is frequently greatly deformed, so that a conveying resistance due to contact of a guide or roller is large. Thus, it is frequently difficult to draw out the banknote. Even if the banknote is drawn out, it may be jammed again in mid course. Moreover, although a guide or structure for separation such as a sensor or roller is mounted on a separating portion, it is difficult to construct a conveying route for securely returning a small foreign matter such as a coin or clip wherever it presents because of a positional relation with the structure. Furthermore, because it is impossible to return the small foreign matter or to sufficiently hold it, it may drop from the conveying route in the middle of return conveying, and it becomes an obstacle when it is conveyed again. These troubles have a large possibility of dropping apparatus out of service which requires recovery by an attendant. Therefore, it is preferable to separate banknotes in the deposit-and-withdrawal port unit 10 close to a user as the case of this embodiment instead of performing general conveying in a lump.

### Embodiment 2

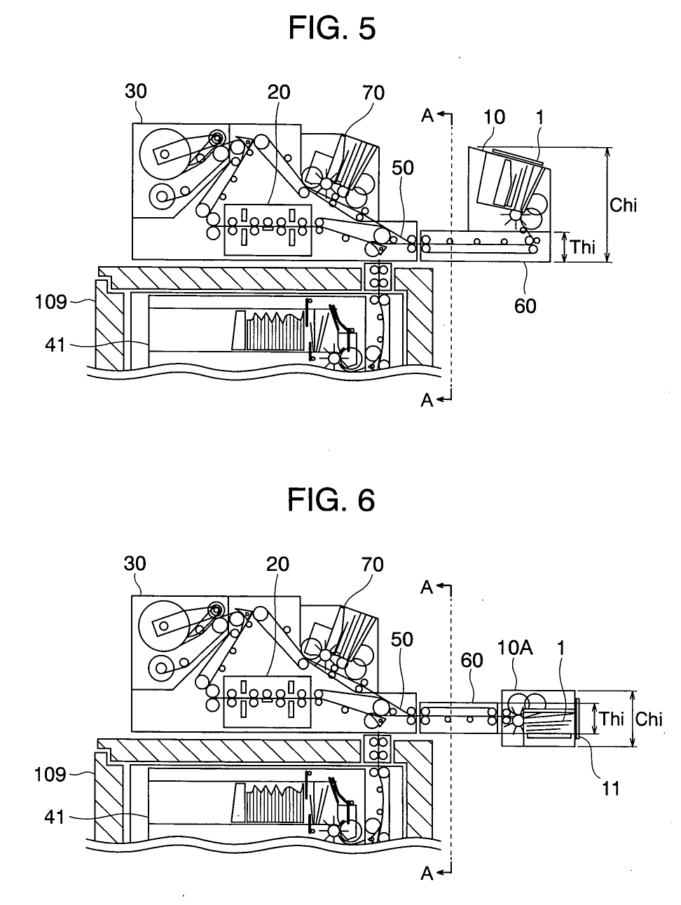

FIG. 5 shows a sectional view of an essential portion of other embodiment of the present invention. This embodiment is different from that in FIG. 4 in that the deposit-and-withdrawal port unit 10 is overlaid the connection conveying route unit 60. Because others are the same as the case of the embodiment in FIG. 4, the same symbols are provided and explanation is omitted.

As shown in FIG. 5, the forefront of the deposit-and-withdrawal port unit 10 of this embodiment is placed at the same position as the forefront of the connection conveying rout unit 60. In this case, the deposit-and-withdrawal port unit 10 and connection conveying route unit 60 are located in the through-hole of the front panel 110. Therefore, the maximum height “Chi” of the portion including the deposit-and-withdrawal port unit 10 becomes the sum of heights of the deposit-and-withdrawal port unit 10 and connection conveying route unit 60.

Therefore, according to this embodiment, although the effect of downsizing the through-hole of a wall is small, it is easy to decrease the height of the connection conveying route unit 60 because the unit 60 has a simple structure composed of a belt and roller. In the case of this embodiment, an example is shown in which the forefront of the connection conveying route unit 60 and that of the deposit-and-withdrawal port unit 10 are coincided. However, it is also possible to partially and longitudinally overlap the connection conveying route unit 60 with the deposit-and-withdrawal port unit 10.

### Embodiment 3

FIG. 6 shows a sectional view of the essential portion of other embodiment. This embodiment is different from those in FIGS. 4 and 5 in that banknotes are substantially horizontally injected into or discharged from a deposit-and-withdrawal port unit 10A, and banknote separating means and banknote collecting means are constituted according to it. That is, in the case of the embodiments in FIGS. 4 and 5, banknotes at the time of separation or collection are kept in a substantially standing position. Therefore, the height of the deposit-and-withdrawal port unit 10 becomes at least the maximum value of shorter dimensions of banknotes to be handled. Moreover, because the conveying route of the connection conveying route unit 60 is substantially horizontally formed, it is necessary to bend the conveying route to the standing position of the separating means and collecting means of the deposit-and-withdrawal port unit 10.

On the contrary, because the deposit-and-withdrawal port unit 10A of the embodiment in FIG. 6 separates and collects banknotes in a substantially horizontal position, it is possible to decrease dimension in height “Chi” because it is enough to make the height corresponding to the maximum number of banknotes which can be injected, independently of the shorter dimension of a banknote. Moreover, this is advantageous for downsizing because the unit 10A can be connected to the connection conveying route unit 60 without changing the conveying direction.

### Embodiment 4

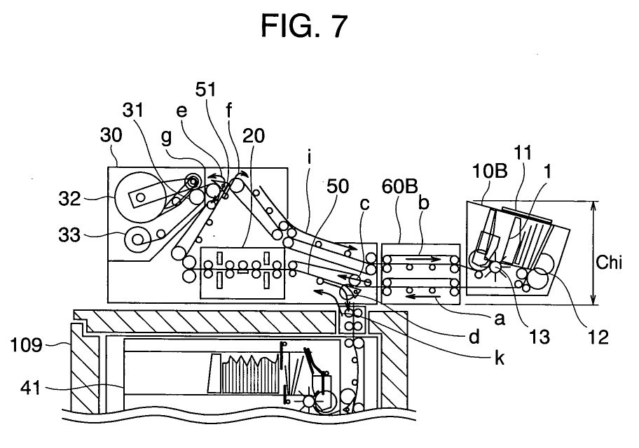

FIG. 7 shows a sectional view of the essential portion of other embodiment of the present invention. This embodiment is different from those in FIGS. 4 and 5 in that the configuration of the deposit-and-withdrawal port unit 10B is different from that of the connection conveying route unit 60B, and the deposit-money reject storage 70 is omitted.

That is, in the case of the deposit-and-withdrawal port unit 10B of this embodiment, the conveying route of the separating mechanism 12 is independent of that of the collecting mechanism 13, and a two-mouth conveying route is constituted in which a banknote bring-out port (separation port) where banknotes are separated by the separating mechanism 12 is different from a bring-in port (collection port) to which banknotes of the collecting mechanism 13 are conveyed. Moreover, the deposit-and-withdrawal port unit 10B can collect banknotes while they are separated, and is constituted to include a partition plate 14 for partitioning separated banknotes and collected banknotes.

The connection conveying route unit 60B independently has a one-directional conveying route in the direction of an arrow “a” connected to the separating mechanism 12 of the deposit-and-withdrawal port unit 10B and a one-directional conveying route in the direction of an arrow “b” connected to the collecting mechanism 13 of the deposit-and-withdrawal port unit 10B. Thereby, even while the deposit-and-withdrawal port unit 10B separates banknotes, it is possible to collect discharged banknotes.

For transaction operations of deposit and withdrawal of this embodiment, only differences from the embodiments in FIGS. 4 and 5 are described. First, banknotes 1 injected into the deposit-and-withdrawal port unit 10B are separated by the separating mechanism 12 one by one, pass through the conveying route of an arrow “a” in the connection conveying route unit 60B, and are conveyed to the conveying route 50. Banknotes conveyed through the conveying route 50 in the direction of an arrow “c” reaches the banknote discriminating portion 20 and the type of money, authenticity, and conveying attitude of banknotes are discriminated. Banknotes which are discriminated to be acceptable by the banknote discriminating portion 20 are conveyed in the direction of the arrow “e” and temporarily stored in the cabinet 30. However, banknotes whose type of money cannot be discriminated by the banknote discriminating portion 20 or banknotes which are discriminated that they are not suitable for conveying due to overlap sending, short pitch, or large skew are conveyed in from an arrow “f” to the direction of an arrow “i”, pass through the conveying route of an arrow “b” in the connection conveying route unit 60B, and are sent to and collected in the deposit-and-withdrawal port unit 10B. The collecting operation can be executed even while the deposit-and-withdrawal port unit 10B separates banknotes. After the deposit-and-withdrawal port unit 10B separates all banknotes, when banknotes are collected in the transaction port of the deposit-and-withdrawal port unit 10B, the shutter 11 is opened to return the banknotes to a user. The user can inject banknotes into the deposit-and-withdrawal port 10B again according to necessity.

When there is no banknote to be re-injected into the deposit-and-withdrawal port unit 10B, an amount of counted money is displayed on the user operating portion 104 to request confirmation to a user. When the mount of counted money is confirmed by the user, the banknotes in the temporary cabinet 30 pass in the directions of arrows “g” and “d”, stored in either of the deposit cashbox 41 or backflow cashbox 43. Thus, the deposit operation is completed.

When a withdrawal designation is supplied, banknotes of designated amount of money are delivered to the conveying route 50 from the withdrawal cashbox 42 or backflow cashbox 43. The delivered banknotes pass in the direction of an arrow “k”, conveyed to the banknote discriminating portion 20, and type of money and conveying attitude are confirmed. A banknote which is discriminated so that withdrawal to a user is improper passes through the arrow “e” and temporarily stored in the temporary cabinet 30. A banknote which is discriminated so that withdrawal to the user is proper passes through arrows “i” and “b”, and collected in the deposit-and-withdrawal port unit 10B. When designated amount of money is collected in the deposit-and-withdrawal port unit 10B, the shutter 11 is opened and banknotes are discharged to a user. When banknotes are stored in the temporary cabinet 30, the banknotes pass in directions of arrows “g” and “d” and are stored in the deposit cashbox 41. Thus, the withdrawal operation is completed.

According to this embodiment, when there is a banknote whose type of money cannot be discriminated by the banknote discriminating portion 20 at the time of deposit or a banknote which cannot be conveyed due to overlap sending, short pitch, or large skew at the time of deposit, it is possible to directly return the banknote to the deposit-and-withdrawal port unit 10 without temporarily storing it in the deposit-money reject storage 70 as the case of other embodiments. Therefore, it is unnecessary to re-separate or recollect banknotes from the deposit-money reject storage 70 to the deposit-and-withdrawal port unit 10. When the separating operation in the deposit-and-withdrawal port unit 10B is completed, deposit reject banknotes are collected in the deposit-and-withdrawal port unit 10B. Therefore, it is possible to decrease the transaction time.

As described above, embodiments of the present invention can be applied to various wall thicknesses “Wth” and the thickness “Sth” of the cashbox 109. Therefore, it is possible to downsize the connection portion to be connected to the front panel 110 of the banknote handling unit 101 and the opening area of a through-hole in a wall. Moreover, it is possible to easily remove a banknote jammed when separating banknotes or a foreign matter.

In the case of each of the above embodiment, an example of applying the present invention to a banknote handling apparatus is described. However, the present invention is not restricted to a banknote. It is possible to apply the present invention to a card handling apparatus for simultaneously handling a plurality of cards. For example, in the case of a card and itemized-slip processor for handling a plurality of cards, because a separating mechanism is necessary for a transaction port unit for injecting or discharging a card, the present invention can be applied. Moreover, when there is an obstacle such as a wall between the body of a wall flush-type KIOSK terminal and a user and a plurality of sheets are handled passing through the terminal, it is possible to minimize the size of a transaction port and easily return a sheet or foreign matter jammed at the time of separation to the user. Therefore, this is effective for improvement of reliability.

It should be further understood by those skilled in the art that although the foregoing description has been made on embodiments of the invention, the invention is not limited thereto and various changes and modifications may be made without departing from the spirit of the invention and the scope of the appended claims.

1. A sheet handling apparatus comprising:
a transaction port unit into or from which a sheet is injected or discharged; and
a sheet handling unit connected to the transaction port unit through a sheet conveying route, the sheet handling unit discriminating the validity of the sheet to take in or discharge the sheet,
wherein a sheet conveying route of the transaction port unit is spaced from a sheet conveying route of the sheet handling unit, and the sheet conveying routes of the transaction port unit and the sheet handling unit are connected through a connection conveying route unit.

2. The sheet handling apparatus according to claim 1, wherein the sheet handling unit is placed inside of a wall of a building and the transaction port unit is positioned in a through-hole passing through the wall.

3. The sheet handling apparatus according to claim 2, wherein a connection end of the sheet conveying route of the connection conveying route unit with the sheet handling unit is positioned inside of the wall.

4. The sheet handling apparatus according to claim 1, wherein the connection conveying route unit includes a substantially horizontal sheet conveying route.

5. The sheet handling apparatus according to claim 1, wherein the connection conveying route unit has a imaginary plane which is vertical to a conveying direction and in which the transaction port unit or the sheet handling unit is not present.

6. The sheet handling apparatus according to claim 1, wherein the transaction port unit is connected to one end of the sheet conveying route of the conveying route unit.

7. The sheet handling apparatus according to claim 1,
wherein the transaction port unit is positioned overlaying at least a part of the connection conveying route unit, and
wherein the sheet conveying route of the transaction port unit includes a vertical sheet conveying route connected to one end of the sheet conveying route of the connection conveying route unit.

8. The sheet handling apparatus according to claim 1, wherein the sheet conveying route of the connection conveying route unit is formed so as to be able to convey sheets in two ways by changing conveying directions.

9. The sheet handling apparatus according to claim 1, wherein the sheet conveying route of the connection conveying route unit is constituted to include a first conveying route heading for the sheet handling unit and a second conveying route heading for the transaction port unit.

10. The sheet handling apparatus according to claim 1,
wherein the transaction port unit has separation means for separating sheets injected into the transaction port one by one to take them in and discharge means for discharging sheets to the transaction port, and
wherein the sheet conveying route of the separation means and that of the discharge means are interflowed and connected to a bidirectional sheet conveying route of the connection conveying route unit.
